(19) United States
(12) Patent Application Publication
(10) Pub. No.: US 2018/0150217 A1
(43) Pub. Date: May 31, 2018

(54) SEARCH METHOD, CLIENT TERMINAL, AND GRAPHICAL USER INTERFACE

(71) Applicant: GUANGZHOU UCWEB COMPUTER TECHNOLOGY CO., LTD., Guangzhou (CN)

(72) Inventors: Hongyuan ZHENG, Guangzhou (CN); Huijun ZHANG, Guangzhou (CN)

(21) Appl. No.: 15/823,816

(22) Filed: Nov. 28, 2017

(30) Foreign Application Priority Data
Nov. 28, 2016 (CN) 201611067703.1

(51) Int. Cl. G06F 3/0488; G06F 17/27

(52) U.S. Cl. CPC G06F 3/04886; G06F 17/30867; G06F 17/275

(57) ABSTRACT

A search method, client terminal, and graphical user interface are provided. The search method includes: obtaining a user input from an input box; displaying at least one vertical search portal in response to the user input; and jumping to a search result page of a selected search portal in response to a portal selection signal from a user.

### CROSS-REFERENCES TO RELATED APPLICATIONS

This application claims priority of Chinese Patent Application No. 201611067703.1, filed on Nov. 28, 2016, the entire contents of which are hereby incorporated by reference.

### FIELD OF THE DISCLOSURE

The present disclosure generally relates to the field of user network interaction technology and, more particularly, relates to a search method, client terminal, and graphical user interface.

### BACKGROUND

A user may access a network to obtain information using a client terminal. How to quickly acquire contents of user's real interest and how to smoothly present the contents to the user have thus become an important goal for all providers.

In the information acquisition process, search function has been frequently used by users over the network. Such search function performed by the users not only involves the use of a comprehensive search engine (such as Google, Baidu and Bing), but also includes the use of a specialized search portal. For example, the search function may be performed to search for merchandise within the Taobao website, to search for book reviews within the Douban website, or to search for comments on a certain topic within the Zhihu website.

Currently, users often have to go through a plurality of operations including: using a comprehensive search engine to search for a certain website, searching certain information within the certain website and clicking to access webpages, and so on, in order to reach the pages that the users actually want to view. These operations are often time-consuming and unsmooth.

The disclosed search method, client terminal, and graphical user interface (GUI) are directed to solve one or more problems set forth above and other problems in the art.

### BRIEF SUMMARY OF THE DISCLOSURE

The present disclosure provides a search solution capable of detecting contents in an input box in real time and providing a variety of search engine portals, thereby optimizing search link paths and providing users with more efficient and smooth search experience.

One aspect of the present disclosure provides a search method. The search method includes: obtaining a user input from an input box; displaying at least one vertical search portal in response to the user input; and jumping to a search result page of a selected search portal in response to a portal selection signal from a user.

Another aspect of the present disclosure provides a client terminal. The client terminal includes: an input device, for receiving a user input; a display device, for displaying an output to a user; a network device, for sending and receiving network information; and a processor connected to the input device, the display device and the network device, for: obtaining the user input from an input box, displaying at least one vertical search portal in response to the user input, and jumping to a search result page of a selected search portal in response to a portal selection signal from a user.

Another aspect of the present disclosure provides a graphical user interface on a hardware device including a touch screen display device. The graphical user interface includes: an input box; an enhancement information bar, for displaying at least one vertical search portal in response to inputted information in the input box; and an search result interface, displaying a search result page of a selected search portal in response to an action detected on the touch screen display device for selecting a search portal.

Other aspects of the present disclosure can be understood by those skilled in the art in light of the description, the claims, and the drawings of the present disclosure.

The search solution provided in the present disclosure shortens the user's actual search path, and accordingly improves search efficiency and the user's network experience.

### BRIEF DESCRIPTION OF THE DRAWINGS

Other aspects and advantages of the present disclosure can be understood by those skilled in the art through the exemplary embodiments of the present disclosure further described in detail with reference to the accompanying drawings. In the disclosed embodiments, same reference numerals and letters generally denote same items.

FIG. 1 illustrates a block diagram of an exemplary computing apparatus for implementing the principles of the present disclosure consistent with disclosed embodiments;

FIG. 2 illustrates a schematic view of an exemplary search method consistent with disclosed embodiments;

FIG. 3 illustrates a flowchart of an exemplary interface presentation of an exemplary search method consistent with disclosed embodiments;

FIG. 4A-C illustrates an exemplary display page of an exemplary implementation consistent with disclosed embodiments;

FIG. 5A-B illustrates an exemplary display page of one or more exemplary search portals according to an exemplary user input consistent with disclosed embodiments;

FIG. 6 illustrates another schematic view of an exemplary search method consistent with disclosed embodiments;

FIG. 7 illustrates a schematic view of an exemplary search device consistent with disclosed embodiments; and

FIG. 8 illustrates a schematic view of an exemplary client terminal consistent with disclosed embodiments.

### DETAILED DESCRIPTION

Hereinafter, detailed description of the embodiments of the present disclosure will be described in more detail with reference to the accompanying drawings. While the embodiments of the present disclosure are shown in the drawings, it should be understood that the present disclosure may be implemented in various forms and should not be limited to the embodiments set forth herein. Rather, the embodiments are provided in order to make the disclosure more thorough and complete, and to fully convey the scope of the present disclosure to those skilled in the art.

When a user uses a client terminal, a hardware device, the user may use a browser or other application programs having page browsing capability installed on the client terminal, and may access and browse webpages via an input editor. In one embodiment, a client terminal may be a computing apparatus.

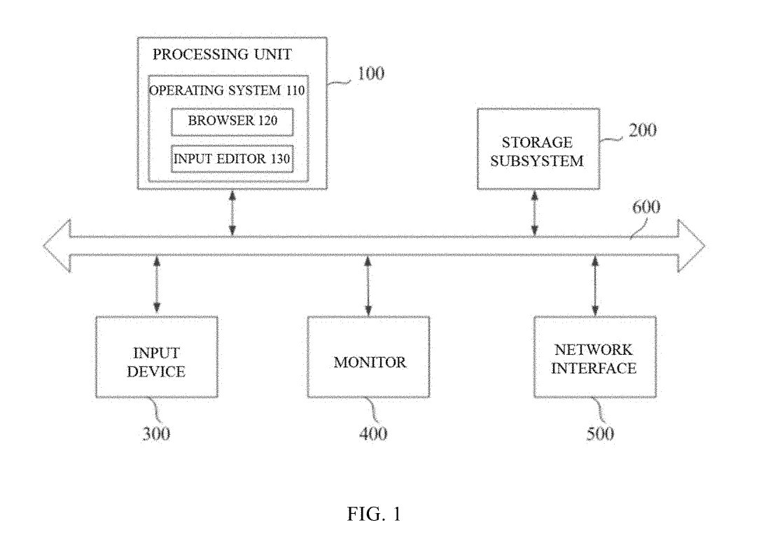

FIG. 1 illustrates a block diagram of an exemplary computing apparatus for implementing the principles of the present disclosure consistent with disclosed embodiments. The computing apparatus may be implemented as various types of computer devices, such as desktop computers, laptop computers, tablet computers, mobile smartphones, personal data assistants (PDA), or other types of computer devices, but is not limited to any form. As shown in FIG. 1, the computing apparatus may be a computer, and the computer may include a processing module 100, a storage subsystem 200, an input device 300, a monitor 400, a network interface 500, and a bus 600.

The processing module 100 may be a single or multi-core processor, or may include a plurality of processors. In certain embodiments, the processing module 100 may include a universal host processor and one or more specific co-processors, such as a graphics processing unit (GPU), a digital signal processor (DSP) and the like. In certain embodiments, the processing module 100 may be implemented using the custom circuits, such as application specific integrated circuit (ASIC) or field-programmable gate array (FPGA). In certain embodiments, the processing module 100 may be implemented using the similar circuit to execute executable instructions stored in the circuit.

In other embodiments, the processing module 100 may execute executable instructions stored on the storage subsystem 200. In various embodiments, as shown in FIG. 1, the processing module 100 may include an operating system 110, a browser 120 (or another application program having page browsing capability) running on the operating system 110, and an input editor 130 embedded in the operating system or installed separately by the user.

The storage subsystem 200 may include various types of storage units, such as system memory, read only memory (ROM), and persistent storage devices. The ROM may store static data or instructions required by the processing module 100 or other modules of the computer. The persistent storage device may include a readable and writable storage device. The persistent storage device may include a non-volatile storage device that does not lose the stored instructions and data even after the computer is powered down. The system memory may include a readable and writable storage device or a volatile readable and writable storage device, such as a dynamic random access memory (DRAM). The system memory may store some or all of the instructions and data required by the processor at runtime.

In addition, the storage subsystem 200 may include a combination of any computer readable storage medium (media), including various types of semiconductor storage chips (such as dynamic random access memory (DRAM), static random access memory (SRAM), synchronous dynamic random access memory (SDRAM), flash memory, programmable read only memory), and magnetic disks and/or optical disks. In certain embodiments, the storage subsystem 200 may include readable and/or writable removable storage devices such as a compact disc (CD), a read-only digital versatile disc, a read-only Blu-ray disc, a super-density disc, a flash memory, a magnetic floppy disk etc. The computer-readable storage medium may not include the carrier wave or transitory electronic signals transmitted by wireless or wired transmission.

A user interface may include one or more user input devices 300, monitors 400, and/or one or more other user output devices. The input device 300 may include a device for a user to input signals to the computer, and the computer may interpret the signals having the user request or information. In certain embodiments, the user may enter the uniform resource locater (URL) to the use interface via a keyboard, requesting the browser 120 to display the web content corresponding to the inputted URL through the user interface.

In other embodiments, using a keyboard, a topic may be inputted via the input editor 130 to the user interface, requesting the browser 120 to display the search results corresponding to the inputted topic through the user interface. In certain embodiments, the input device 300 may include some or all of keyboard buttons, touch screen, mouse, and other input devices.

The monitor 400 may display images generated by the computer, and may include various types of image apparatuses, such as a cathode ray tube (CRT), liquid crystal display (LCD), a light-emitting diode (LED) (including an organic light-emitting diode (OLED)), the projection system etc., and a set of other supporting electronic devices (e.g. DAC, ADC, signal processors, etc.). In certain embodiments, as a supplement to or substitution of the monitor 400, the user may provide other output devices, such as signal lights, speakers, touch sensors, printers and the like.

In certain embodiments, the user interface may include a graphical user interface. In certain areas of the monitor 400, certain visual graphic elements may be defined as interactive objects or control objects which the use may select through the input device 300. For example, a user may operate the input device 300 to move to a certain position for inputting URL, and control the browser to display webpage content on the monitor 400 according to the URL. In certain embodiments, the input device may be a touch device which is able to recognize gestures. The gesture may be associated with an array on the display 300, but not required.

The network interface 500 may provide voice and/or data communication functions for the computer. In certain embodiments, the network interface 500 may include a radio frequency transceiver for transmitting voice and/or data (e.g. the use of cellular telephone technology such as 3G, 4G or EDGE, WIFI data network technology), a GPS receiver, and/or other modules. In certain embodiments, the network interface 500 may provide an additional wireless network connection or an alternative wireless interface. The network interface 500 may be a combination of hardware (such as an antenna, modem, codec, and other analog and/or digital signal processing circuit) and software modules.

The bus 600 may include a variety of buses including a system bus configured to connect various components within the computer, external device buses, and chip buses. For example, the bus 600 may connect the processing module 100 to the storage subsystem 200, and may connect input device 300 to the monitor 400. The bus 600 may connect the computer to the network via the network interface 500 and, accordingly, the computer may be a part of a plurality of networked computing apparatuses. Any or all components of a computer may be used coordinately in the disclosed embodiments.

In certain embodiments, electronic components may be included, such as a microprocessor, and a storage device having computer instructions and data stored on a computer-readable storage medium. Various features illustrated in the disclosed embodiments may be implemented by the method and process of executing computer instructions stored on the computer-readable medium. When the computer instructions are executed, the computer processing unit may perform various functions of the computer instructions. Program instructions or computer codes may be implemented as machine codes, such as the codes acquired using computers, electronic components or microprocessors having parsers to compile other high-level languages.

By suitable programming, the processing module 100 may implement various types of functions for the computer. For example, the processing module 100 may download search results via the network interface 500 and store the search results on the storage subsystem 200, according to the search term which the user may input using the input editor 130. Then, the processing module 100 may read the search results from the storage subsystem 200, may transmit the search results to the browser 120, and may display the search results on the monitor 400.

The computing apparatus shown in FIG. 1 is for illustrative purposes, and may also include other functions not described here in detail (such as mobile call, global positioning system (GPS), power management, camera, a variety of connection ports for external apparatuses or accessories etc.). Further, certain functional modules related to the computing apparatus are described herein, which are for illustrative purposes and do not indicate certain physical configurations for the functional components. In addition, the functional modules may not have one-to-one correspondence with physical modules. The functional modules may be configured to carry out various operations, by e.g. programming or configuring certain control circuits. The functional modules may also be re-configured based on the initial setting. The various embodiments may be implemented in various apparatuses such as electronic apparatuses, by using a combination of hardware and software.

In one implementation, as shown in FIG. 1, the user may input a certain content in an input box of the browser 120 via the input editor 130. When the user inputs a term (e.g. including one or more words), rather than a URL, the browser 120 may obtain the term in the input box and search based on the term, and may provide the search result page to the user. The user may look for and click on a certain link in the search result page to access the website or webpage of interest. In the process of using the browser, search function may be frequently used by users over the network.

In order to optimize the link path, the present disclosure provides a new search solution. The search solution may obtain real-time contents in the search input box and, further in combination with the enhancement bar of the input editor, may provide a variety of vertical search portals, giving users more efficient search experience.

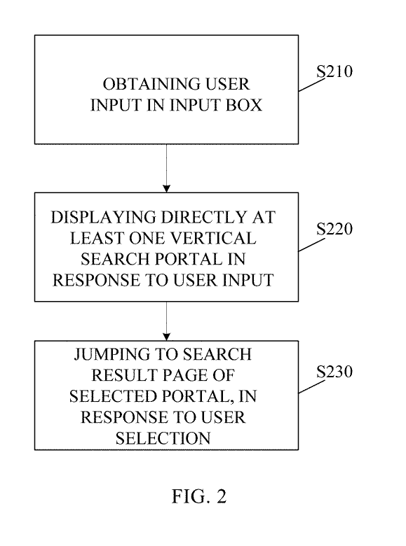

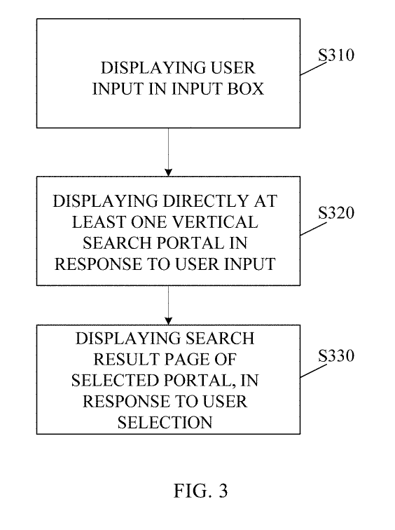

FIG. 2 illustrates a schematic view of an exemplary search method consistent with disclosed embodiments. The search method may be implemented by the computing apparatus shown in FIG. 1. For example, the search method may be implemented by the browser 120 or other application programs having webpage browsing capability, by the input editor 130, or by any application program installed in the computer system. The browser or the input editor may feed the words entered by the user directly into the vertical search portal selected by the user, and directly provide the user with the search results from a certain website or a certain category. Accordingly, the entire search link path may be optimized. FIG. 2 focuses on illustrating the technical solution of the present disclosure from the aspect of certain actions. Accordingly, FIG. 3 illustrates a flowchart of an exemplary interface presentation of an exemplary search method consistent with disclosed embodiments.

As used herein, a “vertical website” may refer to a website focusing on a certain field or certain request, and providing in-depth information and related services for the field or request. For example, a “vertical website” may include Youku and YouTube which specialize in providing video services, the question-and-answer community (Zhihu) for users to share expertise and insights, online shopping websites Taobao and Jingdong, etc. Different from large and comprehensive horizontal websites (also called comprehensive websites), vertical websites may focus on certain fields or certain requests. Similarly, the “vertical search” may provide more oriented specialized results compared to Google and Baidu.

A “vertical search portal” may refer to a search portal directing to specialized search results, which may include a search portal of a certain vertical website and provided by the certain vertical website, may also include a professional search portal for a certain industry or for a certain topic, such as the search portal of “full search for fictions” provided by the UC browser, and may also include a search portal of a certain channel of a certain website, such as the search portal within the sports channel of the Sina website. The vertical search may have broad applications, such as enterprise library search, supply and demand information search engines, shopping search, property search, talent search, map search, mp3 search, image search, etc. Various types of information in various industries may be further refined into various types of vertical search. The search solution of the present disclosure may be based on more professional vertical search.

In step S210, a user input may be obtained from the input box. In the implementation of interface presentation, in step S310, accordingly, the user input may be displayed in the input box. For example, the user input may be obtained by a browser, an application program having browsing function or any other application program from the input box thereof, and may also be obtained directly by the input editor from the input candidate field thereof. Here, the user input may be entered through a physical or virtual keyboard, handwriting input, or other means. In addition, the user may not have to directly enter text. For example, the user may install an input editor application program which supports voice input, such as an input editor application program with a name of “XunFei input method” or “IFlyTek input method”, and may convert voice input to text input via the voice recognition of the application program.

The words may be acquired from the input editor according to a default selection by the input editor or a user selection, based on the user input. For example, when the user enters the Chinese Pinyin “liangjian” in the input box, the corresponding word may be directly obtained based on the default selection of the input editor (e.g. in this case, the word labeled as 1 among the words in the input candidate bar provided by the input editor should be Chinese characters “ [symbol] ”), or may be a user selection (e.g. in this case, the user may select a word in Chinese characters “ [symbol] ” labeled as 2 from the input candidate bar).

The input box for obtaining the user input may be the input box for inputting search terms or website URL, for example, may be the search input box or web address input box provided on the browser home page. And the user input may be the content for search in the scenarios applicable to the present disclosure. Given that the input box already has comprehensive search function by default, the search solution of the present disclosure may provide the user with various vertical search portals, thereby providing users with a full range of search which, by default, may include both the comprehensive search and specialized vertical search.

In step S220, at least one vertical search portal may be displayed in response to the user input. Here, the displayed portal (portals) may include one or more vertical search portals, and may include both vertical search portals and comprehensive search portals. When vertical search portals are provided directly to the user, the user may be able to directly select the search portal for the target web site or target category, thereby avoiding a plurality of operations which are encountered for search in a comprehensive search engine. Accordingly, in step S320, at least one search portal may be shown in the implementation of the interface presentation.

In step S230, the search result page corresponding to the user selected portal may be accessed, in response to portal selection signal of the user. Accordingly, in step S330, the search result page corresponding to the user selected portal may be displayed, in response to portal selection signal of the user.

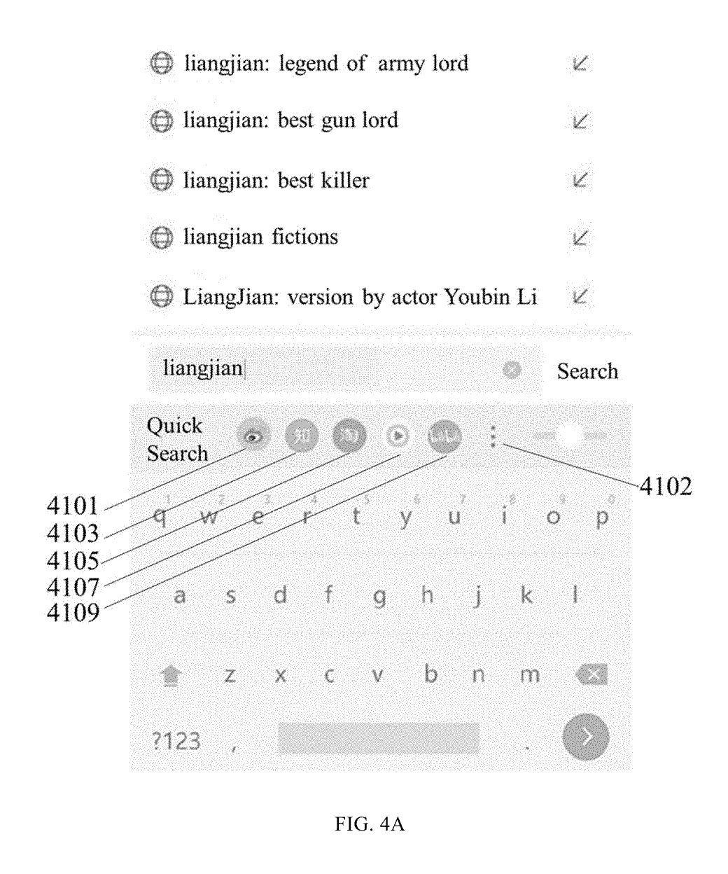

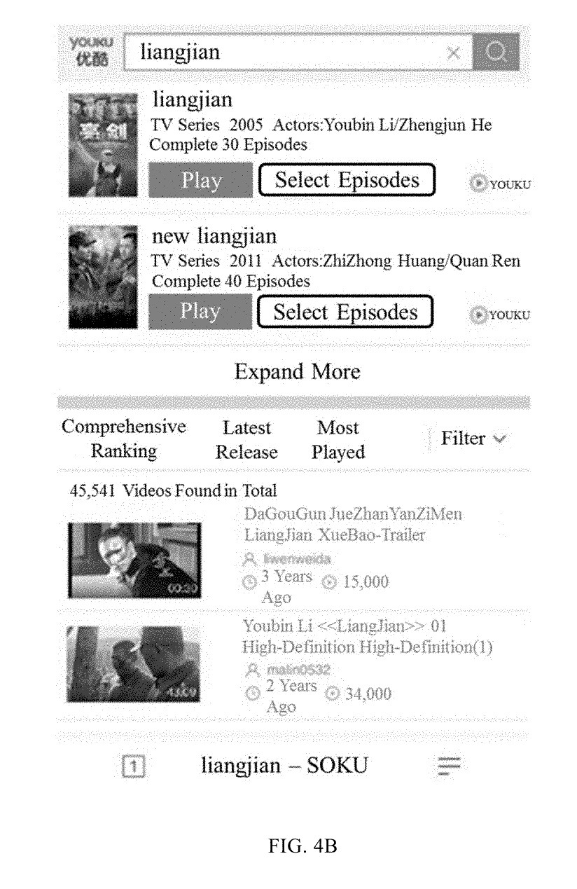

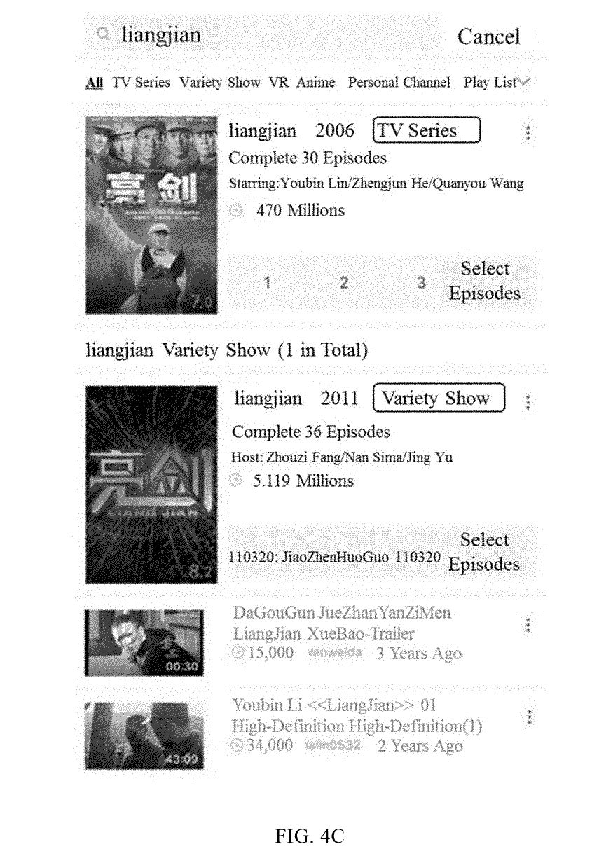

In one embodiment, in step S220 and step S320, displaying at least one vertical search portals may include displaying a plurality of search portals simultaneously, thereby providing the user with a plurality of options. Displayed search portals may include various items for identifying the certain search portals, such as an icon, image with text, link logo etc. In one embodiment, a plurality of simultaneously displayed search portals may include vertical search portals, and comprehensive search portals such as Baidu and Google. In another embodiment, a plurality of simultaneously displayed search portals may include the vertical search portals only, as shown in FIG. 4. FIG. 4 illustrates an exemplary display page of an exemplary implementation consistent with disclosed embodiments, which illustrates an exemplary display page of a mobile computing apparatus such as a smartphone. As shown in FIG. 4A, when the user selected word “liangjian” (the “liangjian” corresponding to Chinese characters “ [symbol] ”) is obtained as the user input, various vertical portal may be displayed to the user, such as the five icons representing the search portals of Sina Weibo (icon 4101), Zhihu (icon 4103), Taobao (icon 4105), Youku (icon 4107), and Bilibili video sharing website (icon 4109), respectively. When the user wants to watch the video named “liangjian”, the user may directly click on the icon for Youku, then may directly access the search result page by the Youku video search on “liangjian”, which may simplify the tedious steps of comprehensive searching, visiting the video website, and further searching on the video website. As shown in FIG. 4A, an item “ . . . ” (4102) may be further displayed after the five icons. The user may click on the item to display the hidden search portals which are not able to show in the single row display bar.

The displayed search results according to the user's click on a certain search portal may be the search result page of the certain search portal opened in the browser, and may also be the search result page displayed in the respective application program (i.e. app) which is directly opened. In the interface presentation, the page may directly jump to the search result page in the same application program; or the respective application program (or default browser) for the selected search engine may be opened to jump to the search result page.

Referring to FIG. 4A, after the user clicks the “Youku” icon, the Youku video search result page may be provided directly in the browser to the user, as shown in FIG. 4B. When the Youku app is already installed on the computing apparatus, the Youku app may be jumped to and the Youku video search result page may be displayed in the Youku app, as shown in FIG. 4C. Which one of the two options may be selected as the default operation may be configured, as desired, by the system (e.g., the corresponding operating system) or the user.

In addition, in the case that an application program other than the browser is used to implement the search solution, according to the user selection on specific search item, the corresponding application program may be opened to display the search result page, or a browser application program may be opened to display the search result page. For example, when an input editor is used to implement the search solution, the user may input the words and select the icon for Youku. Then Youku app may be directly opened to display the search result page for the words, or a browser may be opened to display the search result page for the search words.

For compact and aesthetic considerations, as shown in FIG. 4A, at least one search portal may be provided directly in the input editor enhancement bar. The input editor enhancement bar may be located above the default input editor interface, such as above the virtual keyboard shown in FIG. 4A, and may be located above the candidate box of the input editor. The input editor enhancement bar may be a bar for enhancing the function of the input editor of the browser or other application program, in which secondary characters such as “.com”, “/” and the like may often be added to assist user input. The search portal may also be provided in other locations, such as a bubble or floating window near the input box, or other enhancement information bars near the input box and the like. In one embodiment, search portals may be displayed in only one location. In another embodiment, same or different search portals may be displayed on a plurality of locations for aesthetic or practical considerations.

The provided search portals may be implemented in various means according to actual operation scenarios. In one embodiment, the search portal may be a built-in of the application program. When the technical solution of the present disclosure is implemented by a browser or an input editor, the various search portals may be built-in in the browser or the input editor in advance. In addition, whether or not to update the search portals may be checked during the application program update. For example, for the built-in Youku icon and search portal “http://www.soku.com/m/y/video?q=”, when the application program detects the user input “liangjian” and the click on the Youku icon, the application program may combine the built-in Youku search link with the search content “liangjian” to form the address “http://www.soku.com/m/y/video?q=liangjian”, and may visit the address using the browser or may start Youku app to input the address. Accordingly, the final result displayed to the user may be the result page for searching “liangjian” in the Youku website.

In another embodiment, each search portal may be released in real-time by the server. When the application program for executing the disclosed search solution acquires the user input and send the user input to the application server, the application server may release the search portals in real-time. Given that the application server is able to watch the change of each search portal, such as the change of the search link of a certain vertical website and the address change of a certain vertical search engine etc., search portals may be updated in time by real-time release from the server, to ensure timeliness of the disclosed search solution.

As the supplement to the application program built-in and server-released search portals, the user may add or select their search engine portals, which is well suitable for niche websites. For example, for a user who often has to query the bibliography of books, the user may add the icon of Shanghai Library and the bibliographic search portal of Shanghai library “http://ipac.library.sh.cn/ipac20/ipac.jsp?session=”. In one embodiment, the application program according to the disclosed search solution may further include a list of search portals, and the user may edit the page and select the search portals to show or hide. Further, the list of search portals may be editable, and the user may add the search portal which the user likes but is not listed to the list, and the user may select the sorting position and quantity of the search portals according to the user preference.

Further, every time, the search portals provided to the user may vary according to the user input. The quantity and sorting position of the displayed at least one vertical search portal may be adjusted according to the user input. In one embodiment, the at least one search portal to provide may be selected from a plurality of search portals according to the obtained user input. In another embodiment, two or more search portals may be selected from a plurality of search portals according to the obtained user input, and the sorting positions of the two or more display portals may be determined according to the user input.

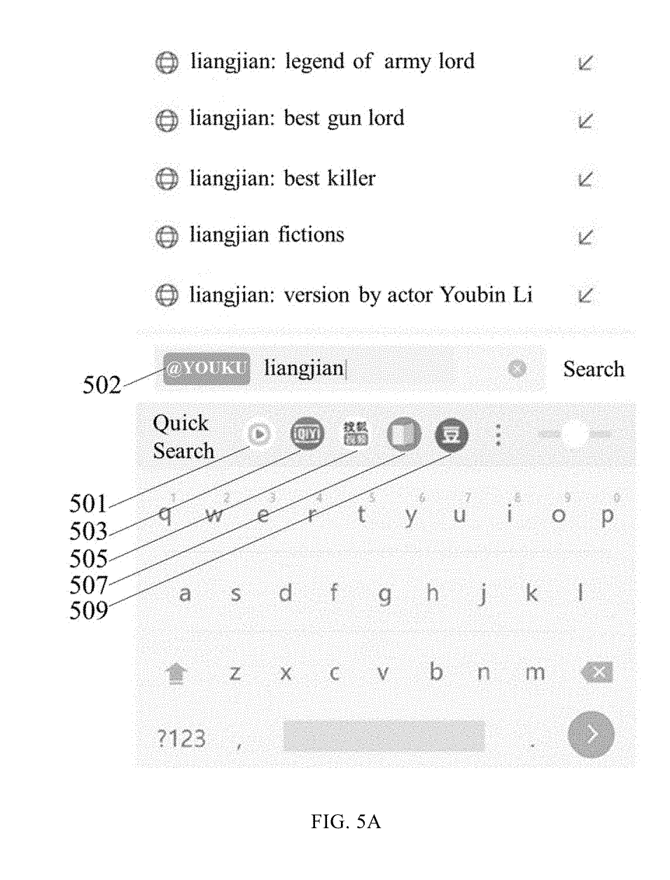

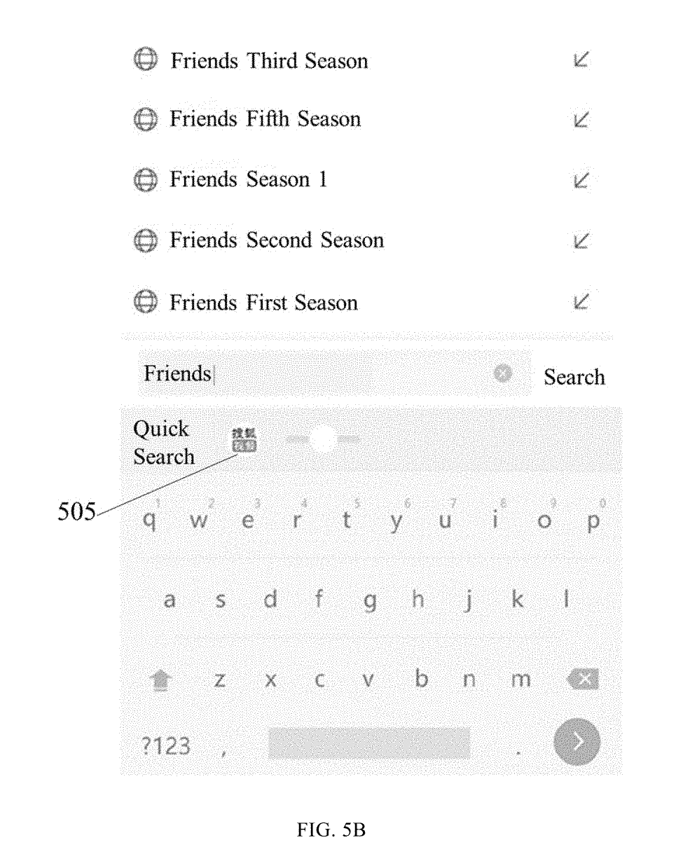

The quantity and sorting position of the search portals determined according to the user input may be determined by the server or application program, in real-time or based on the obtained information. FIG. 5 illustrates an exemplary display page of one or more exemplary search portals according to an exemplary user input consistent with disclosed embodiments. As shown in FIG. 5A, after the user input “liangjian” is obtained, the application program (such as a browser, input editor or other application program) for executing the disclosed search solution may determine that “liangjian” is a hotspot TV series. Accordingly, the first recommendation may be search portals of websites providing the TV series “liangjian”, such as indicated by the “Youku” icon 501, “iQIYI” icon 503, and “Sohu Video” icon 505, as shown in FIG. 5A. Given that the broadcast of TV series may promote reading the respective fiction, the vertical search portal for fictions “full search for fictions” may also be recommended, as indicated by the icon 507 in FIG. 5A. Next recommendation may be the search portal of the movie and book review website “Douban”, as indicated by the icon 509 (i.e. “ [symbol] ”) in FIG. 5A. In one embodiment, the first recommended search engine portal may be configured as the default portal, for example, as indicated by “@YOUKU” (502) in the FIG. 5A. In this case, the user may implement the display of result page based on Youku website search on the search words “liangjian”, by confirming the input in the input box without having to click the “Youku” icon 501.

In certain embodiments, only one search portal may be provided. For example, for the TV sitcom “Friends” broadcast exclusively by “Sohu Video” in mainland China, the icon 505 for “Sohu Video” may be the only displayed icon, as shown in FIG. 5B. Further, different from “@YOUKU” (502) in FIG. 5A, no default portal may be displayed in the corresponding location in FIG. 5B. The preset comprehensive search portal such as Baidu and the like may be still adopted as the default search portal for the input box. Accordingly, as shown in FIG. 5B, the user may click the “Sohu Video” icon 505 to directly acquire the search result page for “Friends” based on the “Sohu Video” search portal, or may directly acquire the search result page based on the default search portal instead of clicking the “Sohu Video” icon 505.

Methods for selecting search portals to provide to users and sorting the search portal based on the user input may vary according to various application scenarios. The selecting and sorting of the search portals may be determined by at least one of a server, an application program, and a user. In certain embodiment, the search portals may be released by the server, and the server may determine what search portals to provide and the sorting positions of the search portals according to the big data access or search hotspots of users.

In certain embodiments, the application program may custom match the vertical search portals according to the user access history or personal preference. For example, when a user input “Kichiku” is obtained, in the case the use often visits websites such as Bilibili video sharing website or has selected “two dimensional space” or “animation” as a character tag, the icon for Bilibili video sharing website may be directly provided to the user or may be prioritized for sorting, such that the user may directly watch videos about “Kichiku”. In the case that the user often visits Zhihu or Baidu Encyclopedia (i.e. Baidu Baike) and is not interested in anime culture generally, the icon for Zhihu or the icon for Baidu Encyclopedia (Baidu Baike) may be provided to the user, such that the user may learn the definition of “Kichiku”. In addition, the application program may maintain a topic-related list and update the list at an appropriate frequency, such that correct search engine portals may be recommended for a certain topic.

Further, given that the user A often visits Zhihu website to look for explanations for various questions or definitions and the user B often visits Baidu Encyclopedia to look for explanations for various questions or definitions, when the user A and user B input an Encyclopedia term such as “Arabica coffee beans”, the search portals of Zhihu website and Baidu Encyclopedia may be recommended to the user A and user B as the first recommendation, respectively, according to the user access history and/or personal preferences.

In certain embodiments, the recommendation and sorting positions of search portals according to the user input may be configured by adding user-defined options. For example, the user may select to prioritize “Zhihu”. Accordingly, the icon for “Zhihu” may be the first recommended search portal, and subsequent search portals may be sorted by the server or the application program.

In another embodiment, the quantity and order (i.e. sorting position) of the displayed search portals for every user search may be based on the combination of two or three of user input, access history and personal preference (including the user-defined options), for example, may be determined by assigning weights to the user input, access history and personal preference.

The exemplary search portals shown in FIG. 4 and FIG. 5 are for illustrative purposes, and are not intended to limit the scope of the present disclosure. In the present disclosure, the disclosed embodiments and the features of the disclosed embodiments may be combined under conditions without conflicts, and non-essential features in the disclosed embodiment may be removed, all of which are within the scope of the present invention. And based on the disclosed embodiments, persons of ordinary skill in the art may derive other embodiments consistent with the present disclosure, all of which are within the scope of the present invention.

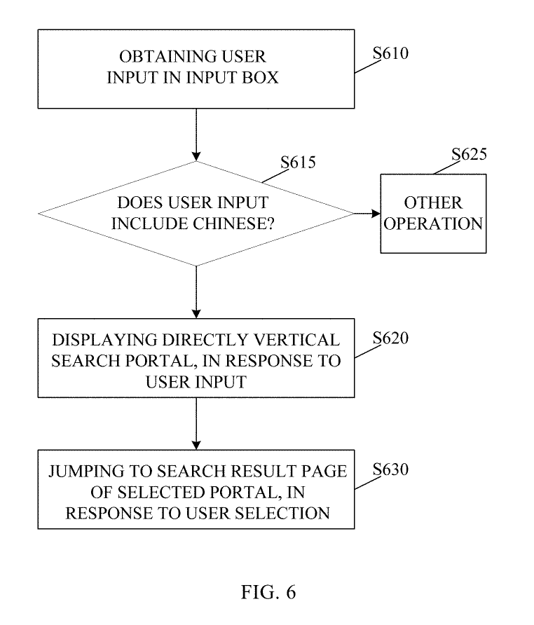

FIG. 6 illustrates a schematic view of an exemplary search method consistent with disclosed embodiments. As shown in FIG. 6, following step S610 in which the user input is obtained, an additional determination step S615 may be added. Subsequently, the display and search operations described in conjunction with step S220 and step S230 may be carried out in response to a word input including Chinese, and other operations may be carried out in response to a word input including no Chinese.

In one embodiment, whether the user input includes a first language which includes Chinese may be determined by the following regular expression:

“̂.*([\u4E00-\uFA29]|[\uE7C7-\uE7F3])+.*$”, where “|” may refer to an operator “OR”, “[\u4E00-\uFA29]” may refer to a first subrange for Chinese characters in Unicode, “\u4E00” may refer to the beginning of the first subrange for Chinese characters in Unicode, “\uFA29” may refer to the end of the first subrange for Chinese characters in Unicode, “[\uE7C7-\uE7F3]” may refer to a second subrange for Chinese characters in Unicode, “\uE7C7” may refer to the beginning of the second subrange for Chinese characters in Unicode, “\uE7F3” refer to the end of the second subrange for Chinese characters in Unicode. Unicode is an international encoding standard for use with different languages and scripts, by which each letter, digit, or symbol is assigned a unique numeric value that applies across different platforms and programs.

Accordingly, “[\u4E00-\uFA29]|[\uE7C7-\uE7F3]” may match any single Chinese character which is in the first subrange for Chinese characters, or in the second subrange for Chinese characters. That is, “[\u4E00-\uFA29]|[\uE7C7-\uE7F3]” may match any single Chinese character. When combining with a preceding item, a “+” may match the preceding item one or more times. Thus, “([\u4E00-\uFA29]|[\uE7C7-\uE7F3])+” may match one or more Chinese characters. “.” may match any single character except a line terminator. When combining with a preceding item, “*” may matches the preceding item 0 or more times. Thus, “.*” may match 0 or more characters not including a line terminator. “̂” may indicate the beginning position of the user input, and “$” may indicate the ending position of the user input. For example, “̂A” may not match the “A” in “an Apple”, but may match the first “A” in “An Apple”; “y$” may not match the “y” in “player”, but may match the “y” in “play”.

Thus, “̂.*([\u4E00-\uFA29]|[\uE7C7-\uE7F3])+.*$” may match a user input including a first language which includes Chinese. For example, if a user input includes 3 parts sequentially: a first set of English characters, Chinese characters, and a second set of English characters, “.*” following “̂” may match the first set of English characters, “([\u4E00-\uFA29]|[\uE7C7-\uE7F3])+” may match the Chinese characters, and “.*” preceding “$” may match the second set of English characters.

For other operations in step S625, in one embodiment, when the user input obtained from the input box is an English word or other characters having no Chinese language, the user may be provided with search portals including at least one comprehensive search portal, and/or provided with URL in English or auxiliary character strings. Accordingly, a more rational operation for search recommendation may be executed in response to the difference between Chinese input and other inputs.

In another embodiment, the additional determination step may determine based on other criteria. In one embodiment, whether or not a user input includes a part of a common URL may be determined. The auxiliary string (such as, “.com”) may be added in response to a user input including a part of a common URL. In response to a user input not including a part of a common URL, vertical search portals may still be recommended to the user. For example, when the user inputs “PPAP”, although the input may include no Chinese, the input may not be a part of a common URL. Accordingly, the search solution of the present disclosure may still be implemented. In one embodiment, the server may determine that “PPAP” is a well-liked comedy video. Thus first recommendations may be icons for video websites such as Youtube, Bilibili video sharing website, Youku etc., for user's direct selection.

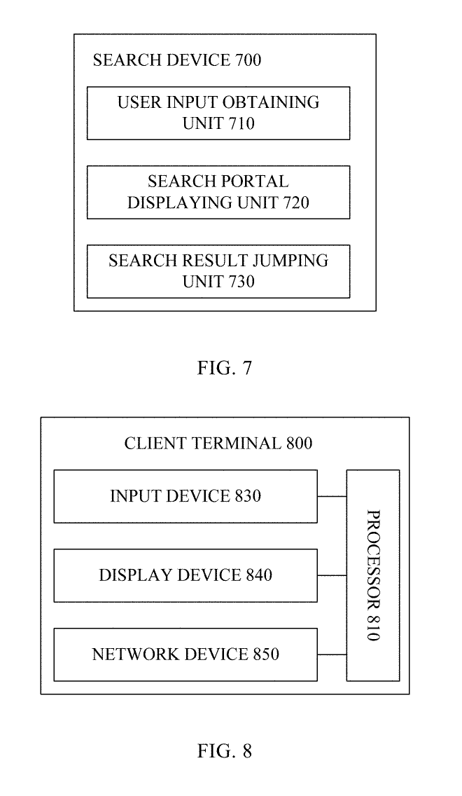

The exemplary search method and various embodiments of the present disclosure are described hereinbefore with reference to the FIG. 2 to FIG. 6. The exemplary search device and client terminal are described hereinafter with reference to FIG. 7 and FIG. 8.

FIG. 7 illustrates a schematic view of an exemplary search device consistent with disclosed embodiments. As shown in FIG. 7, the search device 700 may include a user input obtaining unit 710, a search portal displaying unit 720 and a search result jumping unit 730. The user input obtaining unit 710 may be used for obtaining the user input from the input box. The search portal displaying unit 720 may be used for displaying at least one vertical search portal in response to the user input. The search result jumping unit 730 may be used for jumping to the search result page of the selected portal in response to the portal selection signal of the user.

In one embodiment, the user input obtaining unit 710 may obtain the words from the input editor by default selection of the input editor or by user selection, according to the user input.

In one embodiment, the search portal displaying unit 720 may display a plurality of search portals in respond to the user input. Further, the plurality of search portals may include vertical search portals, which may be combined with the input box having a built-in comprehensive search function and URL input function, to provide an optimized and convenient user navigation solution to meet search needs of various application scenarios.

In one embodiment, at least one search portal may be provided by a server releasing, and/or by a user-defined addition, and/or by a built-in in the application program.

In one embodiment, the search portal displaying unit 720 may adjust the quantity and sorting positions of the displayed vertical search portals, according to the user input, and/or user access history, user preferences, etc. obtained by the user input obtaining unit 710.

Further, the user input obtained from the input box by the user input obtaining unit 710 may be words (or a term) containing Chinese characters, or words determined as non URL words. When the user input obtained from the input box by the user input obtaining unit 710 are words in English or other non-Chinese characters, different auxiliary display operations may be executed.

In one embodiment, the search device may be implemented using one or more processors associated with the search device to realize the functions of the user input obtaining unit 710, the search portal displaying unit 720 and the search result jumping unit 730 of the search device.

FIG. 8 illustrates a schematic view of an exemplary client terminal consistent with disclosed embodiments. In one embodiment, the client terminal may be a computing apparatus shown in FIG. 1. The client terminal 800 may include the respective structures of the computing apparatus shown in FIG. 1. As shown in FIG. 8, the client terminal 800 may include a processor 810, an input device 830, a display device 840 and a network device 850. The processor, the input device, the display device and the network device in FIG. 8 may correspond to the processing module 100, the input device 300, the monitor 400 and the network interface 500 in FIG. 1, respectively.

The input device 830 may be used for receiving the user input. The display device 840 may be used for displaying output to the user. In one embodiment, a touch-screen may integrate the functions of the input device and the display device. The network device 850 may be used for sending and receiving network information. The processor 810 connected to the input device 830, the display device 840 and the network device 850 may be used for: obtaining user input which is entered by the user through the input device 830, from the input box; in response to the user input, displaying at least one vertical search portals; and in response to the user portal selection signal, jumping to the search result page according to the selected portal. In one embodiment, the processor 810 may simultaneously provide a plurality of search portals according to the user input, and determine the display order (i.e. sorting positions) of the plurality of search portals according to the user input. In addition, although not explicitly shown, the computing apparatus may also include a storage device connected to the processor 810 (e.g. corresponding to the storage subsystem 200 in FIG. 1), used as a cache or storage for various information and data.

The search method and the various embodiments described with respect to FIG. 2 to FIG. 6 may be implemented by the search device and client terminal in the FIG. 7 and FIG. 8, which will not be further described here.

In addition, the search solution of the present disclosure may also be implemented as a graphical user interface on a client terminal such as a portable client terminal which includes a touch screen display device. The graphical user interface may include an input box, enhancement information bar and search result interface.

The input box may be used for receiving the user input. The enhancement information bar may display at least one vertical search portal in response to the input information of the input box. And the search result interface may display the search results of the selected portal, in response to detecting an action on the touch screen display device for selecting the search portal.

The enhancement information bar may be an input editor enhancement bar, a bubble or a floating window, and may adjust the quantity and sorting position of displayed at least one vertical search portal according to the user input. In addition, according to the application program including the input box and enhanced information bar, the display may jump to the search result interface in the same application program, or may jump to the respective application program of the selected search portal or browser application program to open the search result interface. The search result interface may include a displayed webpage. In one embodiment, both the input box and enhanced information bar may be built-in in the browser application or other application programs having browsing functions. Accordingly, the search result interface may be directly displayed within the application program or within the specialized application program corresponding to the search portal. In another embodiment, the input box and enhanced information bar may be built-in in the input editor. In this case, the search result interface may be displayed in the default browser or the application program corresponding to the search portal.

The search method, search device, and client terminal of the present disclosure have been described in detail with reference to the accompanying figures. According to the search solution of the present disclosure, the third party search engine may be immediately initiated for a vertical search after the search key word is obtained. Thus, compared to the existing search method by which the user has to use navigation or look for address, access the third party website, and then input key words in the third party website for search, the disclosed solution may simplify the user operation path, improve the user search efficiency and, accordingly, improve the user experience.

A search method, search device, and client terminal are provided in the present disclosure. The method may include: obtaining user input from the input box; in response to the user input, displaying at least one vertical search portal; and in response to a user's portal selection signal, jumping to the search result page of the selected portal. By directly providing the vertical search portal according to the user input, the search link path may be simplified, search efficiency and user experience may be improved.

In addition, the disclosed method of the present disclosure may also be implemented as a computer program including computer program code instructions for performing the above steps defined in the above method of the present disclosure, or may also be implemented as a computer program product which comprises a computer readable storage medium (or media) having computer readable program thereon for performing the above functions defined in the above method of the present disclosure. Those skilled in the art will also understand that the various illustrative logical blocks, modules, circuits and algorithm steps described in combination with the contents disclosed herein may be implemented as an electronic hardware, computer software or combinations of electronic hardware and computer software.

The flowchart and block diagrams in the figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). It should be noted that, in some alternative implementations, the functions noted in the block may occur in an order different from the order noted in the figures. For example, two blocks shown in succession may, in fact, be executed substantially concurrently, or the blocks may sometimes be executed in the reverse order, depending upon the functionality involved. It should also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A search method, comprising:
obtaining a user input from an input box;
displaying at least one vertical search portal in response to the user input; and
jumping to a search result page of a selected search portal in response to a portal selection signal from a user.

2. The method according to claim 1, further including:
adjusting a quantity and a sorting position of the at least one vertical search portal, according to at least one of the user input, an access history, and a user preference.

3. The method according to claim 1, wherein displaying the at least one vertical search portal includes displaying a plurality of search portals.

4. The method according to claim 1, wherein displaying the at least one vertical search portal includes displaying on at least one of:
an input editor enhancement bar;
a bubble or a floating window near the input box; and
an enhancement information bar near the input box.

5. The method according to claim 4, wherein the at least one vertical search portal includes one of:
an icon;
an image with a text;
a link; and
an item capable of identifying a search portal.

6. The method according to claim 1, wherein the at least one vertical search portal is from at least one of:
a server releasing;
a user-defined addition; and
a built-in of an application program.

7. The method according to claim 1, wherein the input box is used for inputting a search or a website, and the user input includes contents for the search.

8. The method according to claim 1, wherein:
displaying the at least one vertical search portal in response to the user input includes:
displaying the at least one vertical search portal in response to the user input including a first language, the first language including Chinese; and
whether the user input includes Chinese is determined by a regular expression:
“̂.*([\u4E00-\uFA29]|[\uE7C7-\uE7F3])+.*$”, wherein:
the “̂” indicates a beginning position of the user input,
the “$” indicates an ending position of the user input,
the “|” refers to an operator “OR”,
the “[\u4E00-\uFA29]” refers to a first subrange for Chinese characters in Unicode,
the “\u4E00” refers to a beginning of the first subrange for Chinese characters in Unicode,
the “\uFA29” refers to an end of the first subrange for Chinese characters in Unicode,
the “[\uE7C7-\uE7F3]” refers to a second subrange for Chinese characters in Unicode,
the “\uE7C7” refers to the beginning of the second subrange for Chinese characters in Unicode,
the “\uE7F3” refers to the end of the second subrange for Chinese characters in Unicode,
“.” matches a single character except a line terminator,
when combining with a preceding item, “+” matches the preceding item one or more times, and
when combining with a preceding item, “*” matches the preceding item 0 or more times.

9. The method according to claim 1, further comprising:
displaying the user input; and
displaying the search result page of the selected search portal.

10. The method according to claim 9, further comprising:
displaying a virtual keyboard for receiving the user input; and
displaying the at least one vertical search portal including: displaying the at least one search portal on an input editor enhancement bar.

11. The method according to claim 9, wherein:
displaying the at least one vertical search portal includes displaying a plurality of search portals; and
a quantity and a sorting position of the at least one vertical search portal are adjusted according to at least one of the user input, an access history, and a user preference.

12. The method according to claim 9, wherein displaying the search result page of the selected search portal includes:
displaying the search result page jumped to in a same application program, or
directly opening a respective application program or browser to display the search result page.

13. A client terminal, comprising:
an input device, for receiving a user input;
a display device, for displaying an output to a user;
a network device, for sending and receiving network information; and
a processor connected to the input device, the display device and the network device, for:
obtaining the user input from an input box,
displaying at least one vertical search portal in response to the user input, and
jumping to a search result page of a selected search portal in response to a portal selection signal from a user.

14. The client terminal according to claim 13, wherein:
the processor displays a plurality of search portals in response to the user input; and
the processor adjusts a quantity and an sorting position of the at least one vertical search portal according to at least one of the user input, an access history, and a user preference.

15. The client terminal according to claim 13, wherein:
the processor displays the at least one vertical search portal on at least one of:
an input editor enhancement bar, a bubble or a floating window near the input box, and an enhancement information bar near the input box; and
the at least one vertical search portal is from at least one of:
a server releasing, a user-defined addition, and a built-in of the search portal displaying unit.

16. The client terminal according to claim 13, wherein:
the processor displays the at least one vertical search portal in response to the user input including a first language, the first language including Chinese.

17. A graphical user interface on a hardware device including a touch screen display device, comprising:
an input box;
an enhancement information bar, for displaying at least one vertical search portal in response to inputted information in the input box; and
an search result interface, displaying a search result page of a selected search portal in response to an action detected on the touch screen display device for selecting a search portal.

18. The graphical user interface according to claim 17, wherein:
the enhancement information bar adjusts a quantity and a sorting position of the at least one vertical search portal according to at least one of the user input, an access history, and a user preference; and
the search result interface includes one of:
the search result interface jumped to within a same application program, and
the search result interface jumped to in a respective application program or a respective browser of the selected search portal after the respective application program or the respective browser is opened.

19. The graphical user interface according to claim 17, wherein:
the hardware device is portable.
